(19) United States
(12) Patent Application Publication
(10) Pub. No.: US 2022/0375027 A1
(43) Pub. Date: Nov. 24, 2022

(54) IMAGE PROCESSING DEVICE AND OPERATION METHOD THEREFOR

(71) Applicant: SAMSUNG ELECTRONICS CO., LTD., Suwon-si (KR)

(72) Inventors: Iljun AHN, Suwon-si (KR); Tammy LEE, Suwon-si (KR)

(73) Assignee: SAMSUNG ELECTRONICS CO., LTD., Suwon-si (KR)

(21) Appl. No.: 17/293,806

(22) PCT Filed: Apr. 3, 2020
(86) PCT No.: PCT/KR2020/004596

§ 371 Date: May 13, 2021

(30) Foreign Application Priority Data
May 16, 2019 (KR) 10-2019-0057605

(51) Int. Cl. G06T 3/40; G06T 7/254

(52) U.S. Cl. CPC G06T 3/40; G06T 7/254; G06T 2207/20224

(57) ABSTRACT

An image processing device includes: a memory storing one or more instructions; and a processor configured to execute the one or more instructions stored in the memory to: obtain location change feature information based on values of pixels included in a first image and relative location relationships of the pixels included in the first image and pixels included in a second image; and generate the second image obtained by up-scaling the first image by k times, by performing a convolution operation on the location change feature information and a kernel, wherein k is a real number.

### TECHNICAL FIELD

Various embodiments relate to an image processing device for performing deconvolution for up-scaling an image, and an operation method therefor.

### BACKGROUND ART

With the development of computer technology, data traffic has increased exponentially and artificial intelligence has become an important trend leading future innovation. The artificial intelligence emulates a human's way of thinking, and thus is practically and unlimitedly applicable to all industries. Representative technologies of artificial intelligence include pattern recognition, machine learning, an expert system, a neural network, natural language processing, and the like.

The neural network is obtained by modeling characteristics of the human's biological neurons by mathematical expression, and uses an algorithm emulating the human ability of learning. Through this algorithm, the neural network may generate mapping between input data and output data, and such a capability of generating the mapping may be expressed as a learning capability of the neural network. Also, the neural network has a generalization capability of generating correct output data for input data that was not used for learning, based on a learning result.

In a convolution neural network (CNN) or the like, a deconvolution layer may be used to generate an output image having a size greater than an input image. However, when an image is up-scaled by a non-integer multiple by using the deconvolution layer, the number of kernels applied to a deconvolution operation is higher than that when the image is up-scaled by an integer multiple. Accordingly, a memory required for the deconvolution operation is increased, and because parallel processing is unable to be performed, a throughput is increased and an operation speed is decreased.

### DESCRIPTION OF EMBODIMENTS

### Solution to Problem

Various embodiments may provide an image processing device capable of reducing a required throughput and memory when performing deconvolution for up-scaling by a non-integer multiple, and an operation method therefor.

### Advantageous Effects of Disclosure

In an image processing device according to an embodiment, the number of kernels required for a deconvolution operation for up-scaling by a non-integer multiple can be reduced.

In an image processing device according to an embodiment, a throughput and memory required when performing deconvolution for up-scaling by a non-integer multiple can be reduced, and an operation speed can be increased.

An image processing device according to an embodiment can up-scale an image in various sizes (resolutions) by performing a deconvolution operation for up-scaling by a non-integer multiple.

An image processing device according to an embodiment can generate an up-scaled image of high quality by performing a deconvolution operation for up-scaling by a non-integer multiple.

### BRIEF DESCRIPTION OF DRAWINGS

FIG. 1 is a diagram showing a method, performed by an image processing device, of generating an image by using a deconvolution operation, according to an embodiment.

FIG. 2 is a diagram for describing a case of up-scaling an image by a non-integer multiple, according to an embodiment.

FIG. 3 is a diagram showing a case of up-scaling a first image by an integer multiple and a case of up-scaling the first image by a real number multiple instead of an integer multiple, according to an embodiment.

FIG. 4 is a diagram for describing a method of determining a tendency of weights included in a kernel applied to deconvolution for up-scaling a first image, according to an embodiment.

FIG. 5 is a diagram for describing a method of modeling a kernel applied to deconvolution for up-scaling a first image, according to an embodiment.

FIG. 6 is a diagram of deconvolution for up-scaling a first image by a non-integer multiple, according to an embodiment.

FIG. 7 is a diagram for describing a process of performing, by an image processing device, deconvolution to up-scale a first image, according to an embodiment.

FIG. 8 is a diagram for describing a method of generating pieces of transform feature information, according to an embodiment.

FIGS. 9 and 10 are diagrams for describing a process of performing, by an image processing device, deconvolution different from the deconvolution of FIG. 7, to up-scale a first image, according to an embodiment.

FIG. 11 is a flowchart of an operation method of an image processing device, according to an embodiment.

FIG. 12 is a block diagram of a configuration of an image processing device, according to an embodiment.

### BEST MODE

An image processing device according to an embodiment includes: a memory storing one or more instructions; and a processor configured to execute the one or more instructions stored in the memory to: obtain location change feature information based on values of pixels included in a first image and relative location relationships of the pixels included in the first image and pixels included in a second image; and generate the second image obtained by up-scaling the first image by k times, by performing a convolution operation on the location change feature information and a kernel, wherein k is a real number.

k may be a real number that is not an integer.

Values of weights included in the kernel may not change according to locations of values of samples included in the location change feature information on which the convolution operation is performed.

The processor may be further configured to execute the one or more instructions to obtain a value of one pixel included in the second image by using values of n pixels among a plurality of pixels included in the first image, and obtain the location change feature information based on relative location relationships of the n pixels with respect to a location of the one pixel.

When the first image and the second image have a same size, locations of the pixels included in the first image may be indicated by i and locations of the pixels included in the second image may be indicated by j, wherein i is an integer and j is a real number, and the processor may be further configured to execute the one or more instructions to: determine kⱼ by performing a rounding-down operation on a value of an index indicated by the one pixel, wherein kⱼ is an integer, and determine uⱼ that is a difference between j and kⱼ; and obtain the location change feature information based on kⱼ and uⱼ.

A distance between adjacent pixels included in the first image may be 1.

The n pixels may be determined based on a value of the index j indicated by the one pixel.

The values of samples included in the location change feature information may be represented as a linear expression for uⱼ.

A number of weights included in the kernel may be determined based on a value of n.

An operation method of an image processing device, according to an embodiment, includes: obtaining location change feature information based on values of pixels included in a first image and relative location relationships of the pixels included in the first image and pixels included in a second image; and generating the second image obtained by up-scaling the first image by k times, by performing a convolution operation on the location change feature information and a kernel, wherein k is a real number.

### MODE OF DISCLOSURE

The terms used in the specification will be briefly defined, and the present disclosure will be described in detail.

All terms including descriptive or technical terms which are used herein should be construed as having meanings that are obvious to one of ordinary skill in the art. However, the terms may have different meanings according to the intention of one of ordinary skill in the art, precedent cases, or the appearance of new technologies. Also, some terms may be arbitrarily selected by the applicant, and in this case, the meaning of the selected terms will be described in detail in the detailed description of the present disclosure. Thus, the terms used herein have to be defined based on the meaning of the terms together with the description throughout the specification.

When a part “includes” or “comprises” an element, unless there is a particular description contrary thereto, the part may further include other elements, not excluding the other elements. In addition, terms such as “unit” and “module” described in the specification denote a unit that processes at least one function or operation, which may be implemented in hardware or software, or implemented in a combination of hardware and software.

Hereinafter, embodiments will be described in detail with reference to the accompanying drawings such that one of ordinary skill in the art may easily implement the present disclosure. However, the present disclosure may be implemented in various different forms and is not limited to embodiments described herein. Also, in the drawings, parts irrelevant to the description are omitted in order to clearly describe the present disclosure, and like reference numerals designate like elements throughout the specification.

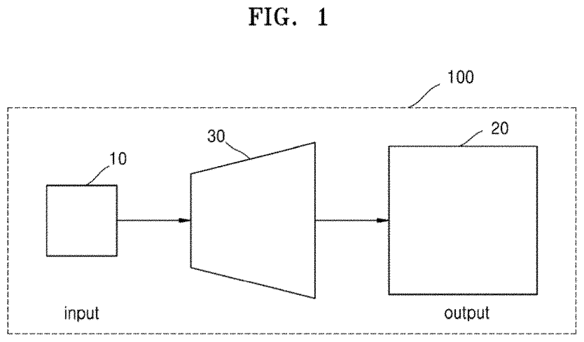

FIG. 1 is a diagram showing a method, performed by an image processing device, of generating an image by using a deconvolution operation, according to an embodiment.

Referring to FIG. 1, an image processing device 100 according to an embodiment may generate an image by using a neural network 20. The image processing device 100 may extract feature information of a first image (input) and generate a second image (output) based on the extracted feature information, by using the neural network 20.

The neural network 20 may include one or more deconvolution layers, and each deconvolution layer may perform a deconvolution operation 30 on a kernel and an image (input) input to the deconvolution layer and generate an output image (output) as a result of the deconvolution operation 30.

The deconvolution operation 30 may be generally used to up-scale an input image in a convolution neural network (CNN), and for example, may be used in various fields, such as super-resolution image generation, auto-encoder, and style transfer. However, the present disclosure is not limited thereto.

A size of the up-scaled second image (output) generated as a result of the deconvolution operation 30 is greater than a size of the first image (input).

Meanwhile, there may be a case where the first image is to be up-scaled by a real number multiple (a non-integer multiple) instead of an integer multiple.

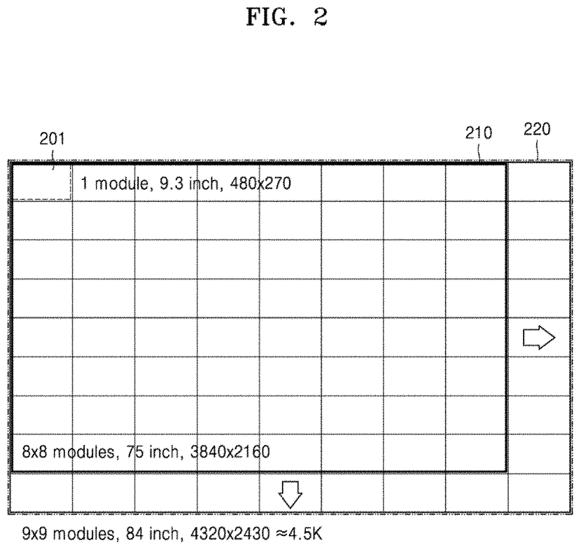

FIG. 2 is a diagram for describing a case of up-scaling on an image by a non-integer multiple, according to an embodiment.

Referring to FIG. 2, a display displaying an image may be configured in units of modules 201, and a size of the display may be variously determined according to a method of combining the modules 201. For example, when one module 201 has a size of 9.8 inches and a resolution of 480×270, a first display 210 including 8×8 modules 201 and having an ultra-high definition (ultra-HD) (4K) resolution may be configured. Alternatively, a second display 220 including 9×9 modules 201 and having a resolution of 4320×2340 (for example, about 4.5K resolution) may be configured.

Here, when an image of a 4K resolution, which is outputtable on the first display 210, is to be output on the second display 220, the image of the 4K resolution may need to be up-scaled by 9/8 times.

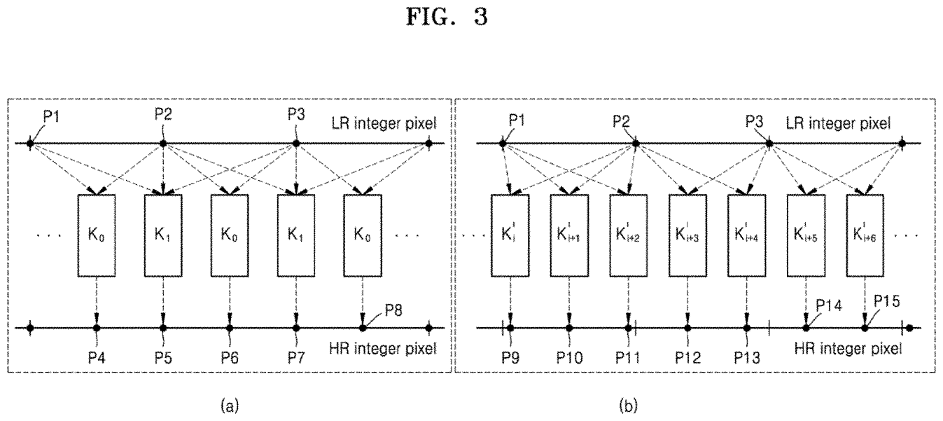

As such, when an image is up-scaled by a real number multiple (a non-integer multiple) instead of an integer multiple by using a deconvolution operation, a number of kernels required for the deconvolution operation may be greater than when the image is up-scaled by an integer multiple. This will be described with reference to FIG. 3.

FIG. 3 is a diagram showing a case of up-scaling a first image by an integer multiple and a case of up-scaling the first image by a real number multiple instead of an integer, according to an embodiment.

(a) of FIG. 3 shows a case where a first image LR is up-scaled by an integer multiple (for example, 2 times). Referring to (a) of FIG. 3, a number of pixels included in a second image HR generated by up-scaling the first image LR by 2 times is two times greater than a number of pixels included in the first image LR.

For example, a value of a fourth pixel P4 included in the second image HR is determined based on values of a first pixel P1 and a second pixel P2 included in the first image LR, and the value of the fourth pixel P4 may be calculated by performing a convolution operation applying a first kernel K₀ on the values of the first pixel P1 and second pixel P2. Here, the first kernel K₀ includes values of weights applied to the values of the first pixel P1 and second pixel P2. The values of weights may be determined based on relative locations of the first pixel P1 and second pixel P2 with respect to the fourth pixel P4, but are not limited thereto.

Also, a value of a fifth pixel P5 included in the second image HR is determined based on values of first to third pixels P1 to P3 included in the first image LR, and the value of the fifth pixel P5 may be calculated by performing a convolution operation applying a second kernel K₁ to the values of the first to third pixels P1 to P3. Here, the second kernel K₁ includes values of weights applied to the values of the first to third pixels P1 to P3. The values of weights may be determined based on relative locations of the first to third pixels P1 to P3 with respect to the fifth pixel P5, but are not limited thereto.

Meanwhile, referring to (a) of FIG. 3, for each of fourth, sixth, and eighth pixels P4, P6, and P8, relative locations of a corresponding pixel and pixels (pixels in the first image LR, input data) used to calculate a value of the corresponding pixel are the same. Accordingly, values of the fourth, sixth, and eighth pixels P4, P6, and P8 may be calculated by applying a same weight (kernel, for example, the first kernel K₀) to the input data.

Similarly, for each of fifth and seventh pixels P5 and P7, relative locations of a corresponding pixel and pixels used to calculate a value of the corresponding pixel are the same, and thus a kernel (for example, the second kernel K₁) applied to calculate the fifth pixel P5 and a kernel (for example, the second kernel K₁) applied to calculate the seventh pixel P7 are the same.

Accordingly, when the first image LR is up-scaled by 2 times, a number of required kernels is 2, and when the first image LR is up-scaled by k1 times (k1 is an integer), the number of required kernels is K1.

(b) of FIG. 3 shows a case where the first image LR is up-scaled by a non-integer multiple (for example, 7/3 times).

For example, a value of a ninth pixel P9 included in the second image HR is determined based on the values of the first pixel P1 and second pixel P2 included in the first image LR, and the value of the ninth pixel P9 may be calculated by performing a convolution operation applying a third kernel Kᵢ on the values of the first pixel P1 and second pixel P2. Here, the third kernel Kᵢ includes the values of weights applied to the values of the first pixel P1 and second pixel P2. The values of weights may be determined based on relative locations of the first pixel P1 and second pixel P2 with respect to the ninth pixel P9.

Also, a value of a tenth pixel P10 may be calculated by performing a convolution operation applying a fourth kernel Kᵢ₊₁ on the values of first pixel P1 and second pixel P2 included in the first image LR. Values of weights included in the fourth kernel Kᵢ₊₁ may be determined based on relative locations of the first pixel P1 and second pixel P2 with respect to the tenth pixel P10.

Meanwhile, referring to (b) of FIG. 3, for each of ninth to fifteenth pixels P9 to P15, relative locations of corresponding pixels and pixels (pixels in the first image LR) used to calculate values of the corresponding pixels are different. Accordingly, a same weight is unable to be applied to input data, and thus seven different kernels are required to determine values of the ninth to fifteenth pixels P9 to P15. In other words, when the first image LR is up-scaled by k2 times (k2 is a real number that is not an integer, k2=NB, wherein A and B are relative primes), A kernels are required.

For example, when the first image LR is up-scaled by 1001/1000 times, a number of kernels required for a deconvolution operation is 1001, and accordingly, a memory and throughput required for the deconvolution operation are highly increased and an operation speed is decreased.

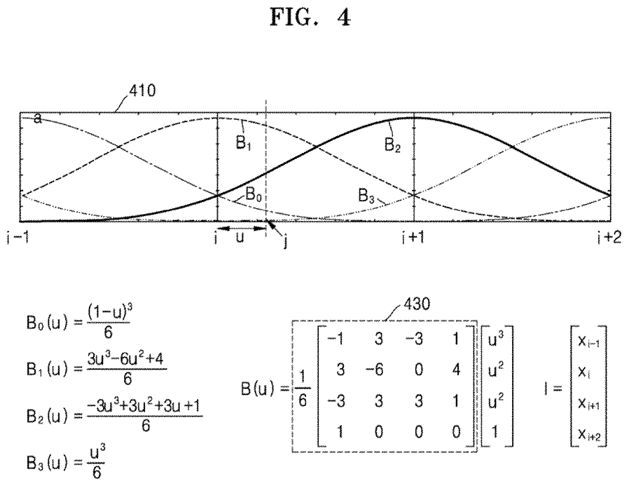

FIG. 4 is a diagram for describing a method of determining a tendency of weights included in a kernel applied to deconvolution for up-scaling a first image, according to an embodiment.

FIG. 4 illustrates an example of applying a cubic B-spline interpolation method to find a tendency of weights applied to values of pixels of the first image, according to locations of pixels of a second image, while calculating values of the pixels of the second image, according to an embodiment.

Referring to FIG. 4, a first graph 410 includes curves B₀(u), B₁(u), B₂(u), and B₃(u) indicating weights respectively applied values of four pixels, xᵢ₋₁, and xᵢ₊₂ of the first image, when the values of pixels of the second image are calculated by using the values of four pixels xᵢ₋₁, xᵢ, and xᵢ₊₂. Here, the curves B₀(u), B₁(u), B₂(u), and B₃(u) are cubic B-spline curves, and as shown in FIG. 4, B₀(u), B₁(u), B₂(u), and B₃(u) are represented as functions for u. A meaning of a variable u will be described in detail below.

For example, when the first image and the second image have a same size and a distance of adjacent pixels included in the first image is 1, locations of the pixels of the first image may be represented in an integer and locations of pixels of the second image may be represented in a real number. For example, the pixels of the first image may be represented in xᵢ (i=0, 1, 2, 3, . . . , n), wherein an index i may indicate a coordinate value (location) of a corresponding pixel. The pixels of the second image may be represented in yⱼ (j=real number), wherein j may indicate a coordinate value (location) of a corresponding pixel.

Referring to FIG. 4, a value of the pixel yⱼ included in the second image may be determined based on the four pixels xᵢ₋₁, xᵢ, xᵢ₊₁, and xᵢ₊₂ among the pixels included in the first image after determining an integer i by performing a rounding-down operation on j.

For example, yⱼ=B₀(u)*xᵢ₋₁+B₁(u)*xᵢ+B₂(u)*xᵢ₊₁+B₃(u)*xᵢ₊₂.

Here, when the first image and the second image have the same size and a point corresponding to the pixel yⱼ included in the second image is located between the pixels xᵢ and xᵢ₊₁ of the first image, u may be a distance between points corresponding to the pixels xᵢ and yⱼ. Referring to FIG. 4, u may be represented as a difference (j−i) between j and a value obtained by rounding down j (for example, the integer i).

Meanwhile, the curves B₀(u), B₁(u), B₂(u), and B₃(u) may be represented as a matrix B(u) as shown in FIG. 4, and the four pixels xᵢ₋₁, xᵢ, xᵢ₊₁, and xᵢ₊₂ of the first image may be represented as a matrix I. Accordingly, the value of the pixel yⱼ may be determined according to Equation 1 below.

yⱼ=<B(u),1>_{F} [Equation 1]

Here, an operation of a sign <A, B>_{F} denotes a convolution operation. In other words, values obtained by multiplying elements at same locations in a matrix A and a matrix B are added.

In the matrix B of FIG. 4, the cubic B-spline curves are applied to find a tendency of weights applied to an input I, and a portion 430 (for example, a coefficient ⅙ and elements of a matrix B′) of the matrix B of FIG. 4 excluding a matrix for u may be determined to be suitable values via training.

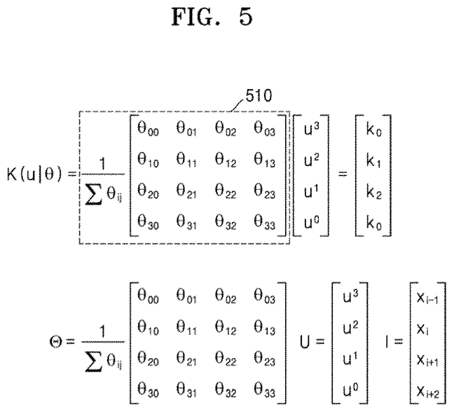

FIG. 5 is a diagram for describing a method of modeling a kernel applied to deconvolution for up-scaling a first image, according to an embodiment.

Referring to FIG. 5, the portion 430 (for example, the coefficient ⅙ and the elements of the matrix B′) of the matrix B of FIG. 4 excluding the matrix for u may be modeled to be represented as θᵢⱼ that is a trainable value, as shown in FIG. 5. Accordingly, a matrix K of FIG. 5 indicates a trainable kernel applied to deconvolution for up-scaling the first image, and may be represented by a multiplication of a trainable matrix Θ 510 and a matrix U. For example, the matrix K may be represented as Equation 2 below.

K(u,θ)=θU [Equation 2]

Here, the matrix Θ 510 and the matrix U may each be represented as shown in FIG. 5.

Also, a deconvolution operation for up-scaling the first image may be represented as Equation 3 below.

yⱼ=<Kⱼ,Iᵢ>_{F}=<ΘUⱼ,1>_{F}=<Θ,Uⱼ·I^{T}> [Equation 3]

In Equation 3, a matrix Iᵢ indicates values of pixels of the first image used to calculate values of pixels yⱼ included in a second image. Also, a location of a matrix Uⱼ may be changed such as to be operated with a matrix Iᵢ instead of the matrix Θ 510.

Accordingly, a matrix Kⱼ (=ΘU) is a matrix indicated by a function of uⱼ and is a space-variant matrix changing according to a value of uⱼ, but the matrix Θ 510 is a space-invariant matrix not changing according to the value of uⱼ. Also, because an order may change in a convolution operation, the values of pixels yⱼ of the second image may be represented as Equation 4 below.

yⱼ=<Uⱼ·Iᵢ^{T},θ>_{F} [Equation 4]

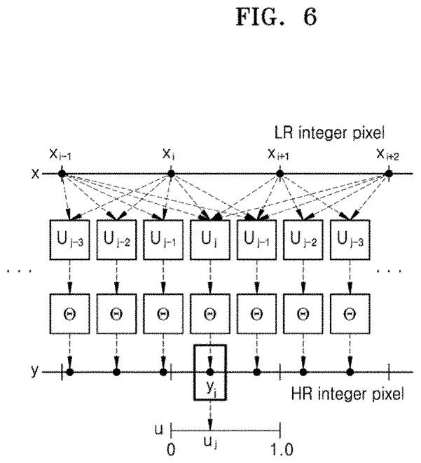

Meanings of parameters in Equation 4 will be described in detail below with reference to FIG. 6.

FIG. 6 is a diagram of deconvolution for up-scaling a first image by a non-integer multiple, according to an embodiment.

Referring to FIG. 6, x denotes the first image and y denotes a second image obtained by up-scaling x by a non-integer multiple. Also, i is a value indicating an index of a pixel included in the first image, and is a value indicating a location of a pixel included in x when x and y have a same size and a distance between adjacent pixels included in the first image is 1. i may be represented in an integer, such as 0, 1, . . . , n. Also, j is a value indicating an index of a pixel included in the second image, and is a value indicating a location of the pixel included in the second image. When locations (for example, coordinates) of pixels of the first image are represented in integers, locations (for example, coordinates) of pixels of the second image may be represented in real numbers. Accordingly, j may be represented in a real number.

As described in FIG. 5, the value of the pixel yⱼ included in the second image may be represented as <Uⱼ·Iᵢ^{T}, Θ>_{F}, and at this time, the matrix Uⱼ is represented in a function for uⱼ and is determined according to a value of uⱼ. Here, the value of uⱼ is determined according to a relative distance between the pixel yⱼ and a pixel xᵢ of the first image. Also, the index i of the pixel xᵢ may be determined to be a value obtained by performing a rounding-down operation on the index j of the pixel yⱼ. For example, when a value of a pixel y_{1.2} is to be obtained, because j is 1.2, 1 obtained by performing a rounding-down operation on 1.2 is the value of i, and xᵢ becomes xᵢ. Also, u_{1.2} becomes 0.2. Accordingly, the matrix Uⱼ is differently determined according to the index j of the value of the pixel yⱼ to be calculated.

Also, the matrix Iᵢ is differently determined according to the index j of the pixel yⱼ. For example, the index i is determined according to the index j, and the matrix Ii=[xᵢ₋₁, xᵢ, xᵢ₊₁, xᵢ₊₂] is determined according to the index i. For example, when the index j is 1.2 and the index i is 1, I₁=[x₀, xᵢ, x₂, x₃]. However, the matrix Ii may be differently configured according to a number of elements included in the matrix Ii.

Meanwhile, the matrix Θ is determined via training, and may be identically applied regardless of the index j of the value of the pixel yⱼ to be calculated, or uⱼ.

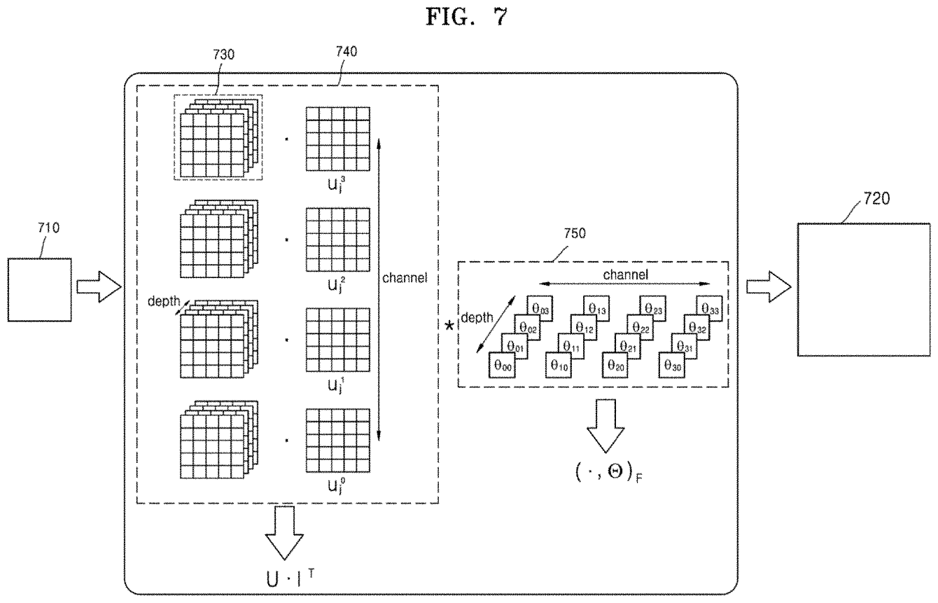

FIG. 7 is a diagram for describing a process of performing, by an image processing device, deconvolution to up-scale a first image, according to an embodiment.

The image processing device 100 according to an embodiment may obtain pieces of location change feature information 740 based on values of pixels included in a first image 710 and relative location relationships of the pixels included in the first image 710 and pixels included in a second image 720.

For example, the image processing device 100 may generate pieces of transform feature information 730 by using the values of pixels included in the first image 710. As shown in FIG. 7, there may be n pieces of transform feature information 730, and at this time, n may be identical to a number of pixels included in the first image 710 used to calculate a value of one pixel included in the second image 720. In FIG. 7, the value of one pixel of the second image 720 is calculated by using values of four pixels included in the first image 710.

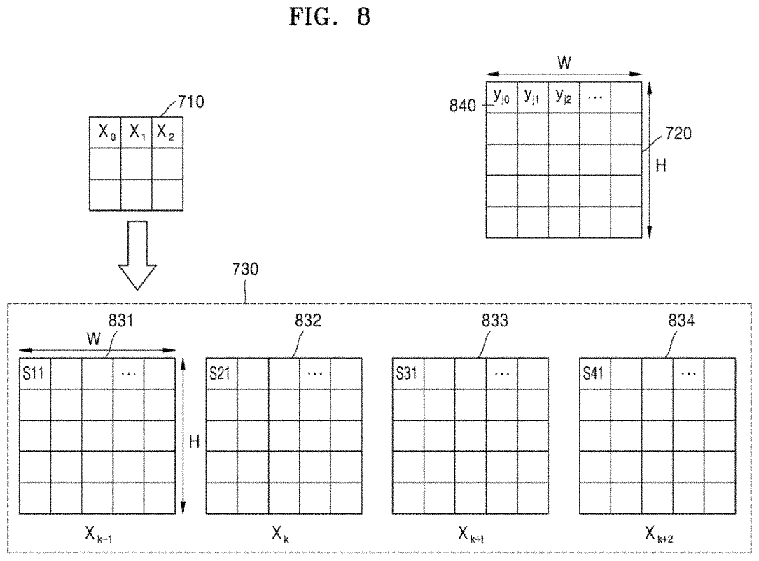

The pieces of transform feature information 730 according to an embodiment may include four pieces of transform feature information (first transform feature information Xₖ₋₁, second transform feature information Xₖ, third transform feature information Xₖ₊₁, and fourth transform feature information Xₖ₊₂. A method of generating the transform feature information 730 will be described in detail with reference to FIG. 8.

FIG. 8 is a diagram for describing a method of generating pieces of transform feature information, according to an embodiment.

Referring to FIG. 8, when the first image 710 and the second image 720 have the same size and the distance of the adjacent pixels included in the first image 710 is 1, the locations of the pixels of the first image 710 may be represented in integers and the locations of the pixels of the second image 720 may be represented in real numbers. For example, the pixels of the first image 710 may be represented in xᵢ (i=0, 1, 2, 3, . . . , n), wherein the index i may indicate a coordinate value (location) of a corresponding pixel. The pixels of the second image 720 may be represented in yⱼ (j=j0, j1, j2, . . . , jm, wherein j is a real number), wherein the index j may indicate a coordinate value (location) of a corresponding pixel. Also, the values of pixels included in the first image 710 may be represented in xᵢ=x₀, x₁, x₂, . . . , xₙ, and the values of pixels included in the second image 720 may be represented in yⱼ=yⱼ₀, yⱼ₁, yⱼ₂, . . . , yⱼₘ.

The pieces of transform feature information 730 may be generated to have a same size as the second image 720. For example, when the size of the second image 720 is W×H, the size of the pieces of transform feature information 730 may also be W×H.

Values of samples included in each of the pieces of transform feature information 730 may be determined based on a location (index) of a pixel of the second image 720 corresponding to each sample. For example, a first pixel 840 of the second image 720 may have a value of an index j₀ and a value k₀ may be determined by performing a rounding-down operation on j₀. Accordingly, values of samples S11 to S41 at locations corresponding to the first pixel 840 may be determined based on the value k₀.

For example, a value of a first sample S11 of first transform feature information 831 is determined to be a value of a pixel xₖ₀₋₁ of the first image 710 having an index of k₀−1, a value of a second sample S21 of second transform feature information 832 is determined to be a value of a pixel xₖ₀ of the first image 710 having an index of k₀, a value of a third sample S31 of third transform feature information 833 is determined to be a value of a pixel Xₖ₀₊₁ of the first image 710 having an index of k₀+1, and a value of a fourth sample S41 of fourth transform feature information 834 is determined to be a value of a pixel Xₖ₀₊₂ of the first image 710 having an index of k₀+2.

In the same manner, the image processing device 100 may obtain first to fourth transform feature information 831 to 834 having a same size as the second image 720.

Referring back to FIG. 7, the image processing device 100 may generate the location change feature information 740 by multiplying uⱼ³, uⱼ², uⱼ¹, and uⱼ⁰ by the first to fourth transform feature information, respectively.

Also, the image processing device 100 may obtain the second image 720 by up-scaling the first image 710 by a non-integer multiple, by performing a convolution operation on the pieces of location change feature information 740 and a kernel 750. Here, values of weights included in the kernel 750 may not change according to locations of values of samples included in the pieces of location change feature information 740 on which the convolution operation is performed. A number of the weights included in the kernel 750 may be determined based on the number n of pixels included in the first image 710 used to calculate a value of one pixel included in the second image 720.

For example, a value of the pixel yⱼ₀ of the second image 720 up-scaled as the deconvolution operation of FIG. 7 is performed on the first image 710 may be represented as Equation 5 below.

yⱼ₀=(θ₀₀uⱼ₀³x₀+θ₀₁uⱼ₀³x₁+θ₀₂uⱼ₀³x₂+θ₀₃uⱼ₀³x₃)+(θ₁₀uⱼ₀³x₀+θ₁₁uⱼ₀³x₁+θ₁₂uⱼ₀³x₂+θ₁₃uⱼ₀³x₃)+(θ₂₀uⱼ₀³x₀+θ₂₁uⱼ₀³x₁+θ₂₂uⱼ₀³x₂+θ₂₃uⱼ₀³x₃)+(θ₃₀uⱼ₀³x₀+θ₃₁uⱼ₀³x₁+θ₃₂uⱼ₀³x₂+θ₃₃uⱼ₀³x₃) [Equation 5]

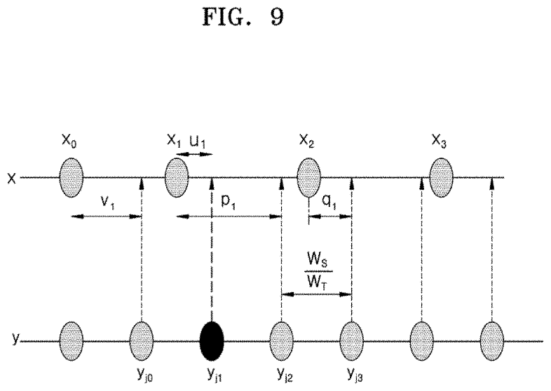

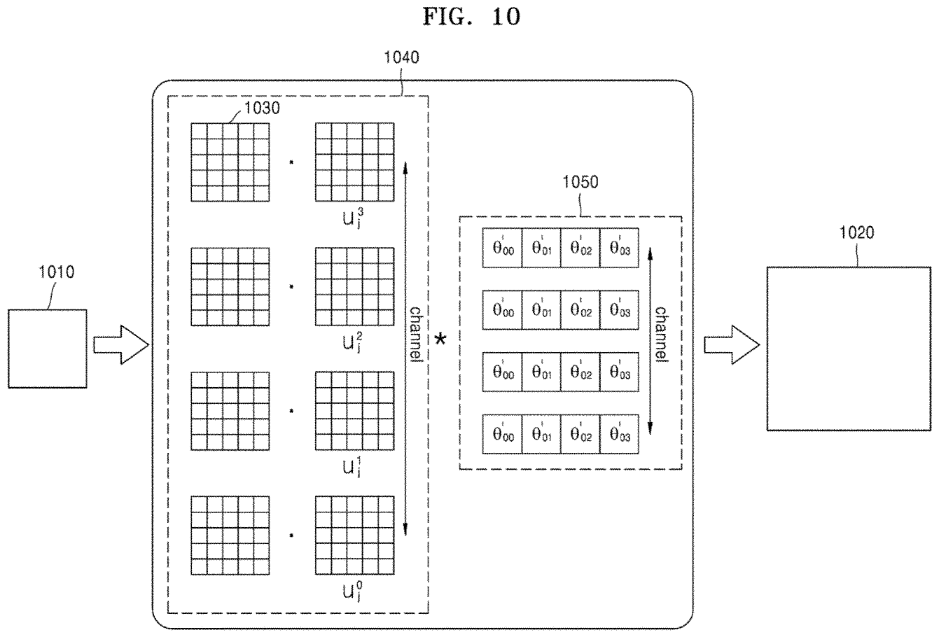

FIGS. 9 and 10 are diagrams for describing a process of performing, by an image processing device, deconvolution different from the deconvolution of FIG. 7, to up-scale a first image, according to an embodiment.

Referring to FIG. 9, yⱼ may be calculated by using variables of vⱼ, pⱼ, and qⱼ in addition to uⱼ.

The variables vⱼ, pⱼ, and qⱼ may be represented as a function for uⱼ as indicated in Equation 6, and may be represented as a nonlinear function for uⱼ.

$${v}_{j} = 1 + {u}_{j} - \frac{{W}_{S}}{{W}_{T}} \qquad [ Equation 6 ]$$

$${p}_{j} = {u}_{j} + \frac{{W}_{S}}{{W}_{T}}$$

$${q}_{j} = {u}_{j} + 2 \times \frac{{W}_{S}}{{W}_{T}} - 1$$

Here, W_{S} denotes a size of a first image and W_{T} denotes a size of a second image.

For example, Equation 5 may be modified as Equation 7 below by using relationships between uⱼ and the variables vⱼ, pⱼ, and qⱼ of Equation 6.

yⱼ₀=(θ′₀₀uⱼ₀³x₀+θ′₀₁uⱼ₀³x₁+θ′₀₂uⱼ₀³x₂+θ′₀₃uⱼ₀³x₃)+(θ′₁₀uⱼ₀³x₀+θ′₁₁uⱼ₀³x₁+θ′₁₂uⱼ₀³x₂+θ′₁₃uⱼ₀³x₃)+(θ′₂₀uⱼ₀³x₀+θ′₂₁uⱼ₀³x₁+θ′₂₂uⱼ₀³x₂+θ′₂₃uⱼ₀³x₃)+(θ′₃₀uⱼ₀³x₀+θ′₃₁uⱼ₀³x₁+θ′₃₂uⱼ₀³x₂+θ′₃₃uⱼ₀³x₃) [Equation 7]

Also, vⱼ, pⱼ, and qⱼ may be represented as Equation 8 below.

vⱼ=uⱼ₋₁

pⱼ=uⱼ₊₁

qⱼ=uⱼ₊₂ [Equation 8]

By using Equations 7 and 8, yⱼ₊₁ may be represented in a general equation, such as Equation 9 below.

yⱼ₊₁=(θ′₀₀uⱼ³xᵢ+θ′₀₁uⱼ₊₁³xᵢ₊₁+θ′₀₂uⱼ₊₂³xᵢ₊₂+θ′₀₃uⱼ₊₃³xᵢ₊₃)+(θ′₁₀uⱼ³xᵢ+θ′₁₁uⱼ₊₁³xⱼ₊₁+θ′₁₂uⱼ₊₂³xᵢ₊₂+θ′₁₃uᵢ₊₃³xⱼ₊₃)+(θ′₂₀uⱼ³xᵢ+θ′₂₁uⱼ₊₁³xᵢ₊₁+θ′₂₂uⱼ₊₂³xᵢ₊₂+θ′₂₃uⱼ₊₃³xᵢ₊₃)+(θ′₃₀uⱼ³xᵢ+θ′₃₁uⱼ₊₁³xᵢ₊₁+θ′₃₂uⱼ₊₂³xᵢ₊₂+θ′₃₃uⱼ₊₃³xᵢ₊₃) [Equation 9]

FIG. 10 is a diagram showing an operation process of Equation 9, and transform feature information 1030 shown in FIG. 10 may be the second transform feature information 832 among the four pieces of transform feature information 730 of FIG. 7.

The image processing device 100 may generate pieces of location change feature information 1040 from a first image 1010 by multiplying uⱼ³, uⱼ², uⱼ¹, and uⱼ⁰ respectively to the transform feature information 1030 ( [symbol] ). Also, the image processing device 100 may obtain a second image 1020 in which the first image 1010 is up-scaled by a non-integer multiple by performing a convolution operation on the pieces of location change feature information 1040 and a kernel 1050. Here, values of weights included in the kernel 1050 may not change according to locations of values of samples included in the pieces of location change feature information 1040 on which the convolution operation is performed. A number of the weights included in the kernel 1050 may be determined based on a number n of pixels included in the first image 1010 used to calculate a value of one pixel included in the second image 1020.

For example, a value of a pixel yⱼ₁ of the second image 1020 up-scaled as the deconvolution operation of FIG. 10 is performed on the first image 1010 may be represented as Equation 10 below.

yⱼ₁=(θ′₀₀uⱼ₀³x₀+θ′₀₁uⱼ₁³x₁+θ′₀₂uⱼ₂³x₂+θ′₀₃uⱼ₃³x₃)+(θ′₁₀uⱼ₀³x₀+θ′₁₁uⱼ₁³x₁+θ′₁₂uⱼ₂³x₂+θ′₁₃uⱼ₃³x₃)+(θ′₂₀uⱼ₀³x₀+θ′₂₁uⱼ₁³x₁+θ′₂₂uⱼ₂³x₂+θ′₂₃uⱼ₃³x₃)+(θ′₃₀uⱼ₀³x₀+θ′₃₁uⱼ₁³x₁+θ′₃₂uⱼ₂³x₂+θ′₃₃uⱼ₃³x₃) [Equation 10]

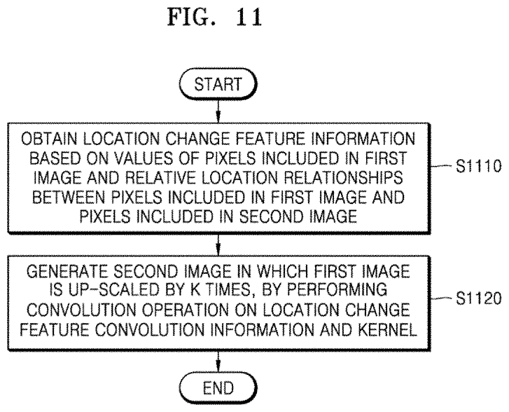

FIG. 11 is a flowchart of an operation method of an image processing device, according to an embodiment.

Referring to FIG. 11, the image processing device 100 according to an embodiment may obtain relative location relationships between pixels included in a first image and pixels included in a second image, and obtain location change feature information based on the obtained location relationships and values of the pixels included in the first image, in operation S1110.

The image processing device 100 according to an embodiment obtains a value of one pixel in the second image by using values of n pixels among the plurality of pixels included in the first image. Here, relative location relationships of the n pixels in the first image with respect to a location of the one pixel in the second image may be obtained.

For example, when the first image and the second image have a same size and a distance between adjacent pixels in the first image is 1, locations of the pixels included in the first image may be indicated by an index i (i=integer) and locations of pixels included in the second image may be indicated by an index j (j=real number). For example, x₀ and x₁ may denote values of pixels located at coordinates 0 and 1 in the first image, respectively, and y_{0.2} may denote a value of a pixel located at a coordinate 0.2 in the second image.

The image processing device 100 may determine k by performing a rounding-down operation on a value of the index j indicated by the pixel included in the second image, and determine uⱼ that is a difference between kⱼ and the index j indicated by the pixel. For example, in a case of y_{0.2}, kⱼ may be determined to be 0 and uⱼ may be determined to be 0.2.

The image processing device 100 according to an embodiment may obtain location change feature information based on kⱼ, uⱼ, and the number of pixels of the first image used to obtain the value of one pixel of the second image. Because a method of obtaining the location change feature information has been described in detail with reference to FIGS. 7 through 10, detailed descriptions thereof are not provided again.

The image processing device 100 may generate the second image in which the first image is up-scaled by k times (k is a real number) by performing a convolution operation on the location change feature information and a kernel, in operation S1120.

Here, k may denote a real number that is not an integer, and a size of the kernel (for example, a number of weights included in the kernel) may be determined based on the number n of the pixels in the first image used to obtain the value of one pixel in the second image. Values of the weights included in the kernel do not change according to locations of values of samples included in the location change feature information on which the convolution operation is performed.

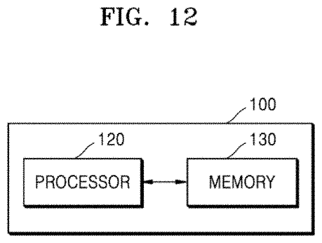

FIG. 12 is a block diagram of a configuration of an image processing device, according to an embodiment.

Referring to FIG. 12, the image processing device 100 according to an embodiment may include a processor 120 and a memory 130.

Also, the processor 120 according to an embodiment may control overall operations of the image processing device 100. The processor 120 according to an embodiment may execute one or more programs stored in the memory 130.

The memory 130 according to an embodiment may store various types of data, programs, or applications for driving and controlling the image processing device 100. The program stored in the memory 130 may include one or more instructions. The program (one or more instructions) or application stored in the memory 130 may be executed by the processor 120.

The processor 120 according to an embodiment may obtain relative location relationships between pixels included in a first image and pixels included in a second image, and obtain location change feature information based on the obtained location relationships and values of the pixels included in the first image.

The processor 120 according to an embodiment obtains a value of one pixel in the second image by using values of n pixels among the plurality of pixels included in the first image. Here, relative location relationships of n pixels in the first image with respect to a location of the one pixel in the second image may be obtained. For example, when the first image and the second image have a same size and a distance between adjacent pixels in the first image is 1, locations of the pixels included in the first image may be indicated by an index i (i=integer) and locations of pixels included in the second image may be indicated by an index j (j=real number).

The processor 120 may determine k by performing a rounding-down operation on a value of the index j indicated by the pixel included in the second image, and determine uⱼ that is a difference between kⱼ and the index j indicated by the pixel. For example, in a case of y_{0.2}, kⱼ may be determined to be 0 and uⱼ may be determined to be 0.2.

The processor 120 according to an embodiment may obtain location change feature information based on kⱼ, uⱼ, and the number of pixels of the first image used to obtain the value of one pixel of the second image. Because a method of obtaining the location change feature information has been described in detail with reference to FIGS. 7 through 10, detailed descriptions thereof are not provided again.

The processor 120 may generate the second image in which the first image is up-scaled by k times (k is a real number) by performing a convolution operation on the location change feature information and a kernel. Here, k may denote a real number that is not an integer, and a size of the kernel (for example, a number of weights included in the kernel) may be determined based on the number n of the pixels in the first image used to obtain the value of one pixel in the second image. Values of the weights included in the kernel do not change according to locations of values of samples included in the location change feature information on which the convolution operation is performed.

Also, the values of weights included in the kernel according to an embodiment are values determined via training, and the values of weights determined via training may be stored in the memory 130.

Meanwhile, the block diagram of the image processing device 100 of FIG. 12 is a block diagram according to an embodiment. Components of the block diagram may be integrated, a component may be added, or a component may be omitted according to the specification of the image processing device 100. In other words, two or more components may be integrated into one component or one component may be divided into two or more components when necessary. Also, a function performed by each block is only for describing embodiments and specific operations or apparatuses do not limit the scope of right of the present disclosure.

An operation method of an image processing device, according to an embodiment, may be recorded on a computer-readable recording medium by being implemented in a form of program commands executed by using various computers. The computer-readable recording medium may include at least one of a program command, a data file, and a data structure. The program commands recorded in the computer-readable recording medium may be specially designed or well known to one of ordinary skill in the computer software field. Examples of the computer-readable recording medium include magnetic media such as hard disks, floppy disks, and magnetic tapes, optical media such as CD-ROMs and DVDs, magneto-optical media such as floptical disks, and hardware devices specially configured to store and perform program commands, such as read-only memory (ROM), random-access memory (RAM), and flash memory. Examples of the computer command include mechanical codes prepared by a compiler, and high-level languages executable by a computer by using an interpreter.

Furthermore, the image processing device and the operation method of the image processing device, according to embodiments, may be provided by being included in a computer program product. The computer program products are products that can be traded between sellers and buyers.

The computer program product may include a software program or a computer-readable storage medium storing a software program. For example, the computer program product may include a product (for example, a downloadable application) in a form of a software program that is electronically distributable through a manufacturer of the electronic device or an electronic market (for example, Google PlayStore™ or AppStore™). For electronic distribution, at least a part of the software program may be stored in the storage medium or temporarily generated. In this case, the storage medium may be a storage medium of a server of a manufacturer, a server of an electronic market, or a relay server that temporarily stores the software program.

The computer program product may include a storage medium of a server or a storage medium of a client apparatus in a system including the server and the client apparatus. Alternatively, when there is a third device, e.g., a smartphone, that communicates with the server or the client apparatus, the computer program product may include a storage medium of the third device. Alternatively, the computer program product may include the software program transmitted from the server to the client apparatus or the third device, or transmitted from the third device to the client apparatus.

In this case, one of the server, the client apparatus, and the third device may perform a method according to embodiments of the disclosure by executing the computer program product. Alternatively, two or more of the server, the client apparatus, and the third device may execute the computer program product to perform the method according to the embodiments of the disclosure in a distributed fashion.

For example, the server, for example, a cloud server or an artificial intelligence server, may execute the computer program product stored in the server to control the client apparatus communicatively connected to the server to perform the method according to the embodiments.

While the embodiments have been particularly shown and described in detail, it will be understood by one of ordinary skill in the art that various changes in form and details may be made therein without departing from the spirit and scope of the present disclosure as defined by the following claims.

1. An image processing device comprising:
a memory storing one or more instructions; and
a processor configured to execute the one or more instructions stored in the memory to:
obtain location change feature information based on values of pixels included in a first image and relative location relationships of the pixels included in the first image and pixels included in a second image; and
generate the second image obtained by up-scaling the first image by k times, by performing a convolution operation on the location change feature information and a kernel, wherein k is a real number.

2. The image processing device of claim 1, wherein k is a real number that is not an integer.

3. The image processing device of claim 1, wherein values of weights included in the kernel do not change according to locations of values of samples included in the location change feature information on which the convolution operation is performed.

4. The image processing device of claim 1, wherein the processor is further configured to execute the one or more instructions to obtain a value of one pixel included in the second image by using values of n pixels among a plurality of pixels included in the first image, and obtain the location change feature information based on relative location relationships of the n pixels with respect to a location of the one pixel.

5. The image processing device of claim 4, wherein, when the first image and the second image have a same size, locations of the pixels included in the first image are indicated by i and locations of the pixels included in the second image are indicated by j, wherein i is an integer and j is a real number, and
the processor is further configured to execute the one or more instructions to:
determine kⱼ by performing a rounding-down operation on a value of an index indicated by the one pixel, wherein kⱼ is an integer, and determine uⱼ that is a difference between j and kⱼ; and
obtain the location change feature information based on kⱼ and uⱼ.

6. The image processing device of claim 5, wherein a distance between adjacent pixels included in the first image is 1.

7. The image processing device of claim 5, wherein the n pixels are determined based on a value of the index j indicated by the one pixel.

8. The image processing device of claim 5, wherein the values of samples included in the location change feature information are represented as a linear expression for uⱼ.

9. The image processing device of claim 4, wherein a number of weights included in the kernel is determined based on a value of n.

10. An operation method of an image processing device, the operation method comprising:
obtaining location change feature information based on values of pixels included in a first image and relative location relationships of the pixels included in the first image and pixels included in a second image; and
generating the second image obtained by up-scaling the first image by k times, by performing a convolution operation on the location change feature information and a kernel, wherein k is a real number.

11. The operation method of claim 10, wherein k is a real number that is not an integer.

12. The operation method of claim 10, wherein values of weights included in the kernel do not change according to locations of values of samples included in the location change feature information on which the convolution operation is performed.

13. The operation method of claim 10, wherein the obtaining of the location change feature information comprises obtaining the location change feature information based on relative location relationships of n pixels included in the first image with respect to a location of one pixel included in the second image,
wherein the n pixels are pixels used to obtain a value of the one pixel.

14. The operation method of claim 13, wherein, when the first image and the second image have a same size, locations of the pixels included in the first image are indicated by i and locations of the pixels included in the second image are indicated by j, wherein i is an integer and j is a real number, and
the obtaining of the location change feature information comprises determining kⱼ by performing a rounding-down operation on a value of an index indicated by the one pixel, wherein kⱼ is an integer, determine uⱼ that is a difference between j and kⱼ, and obtaining the location change feature information based on kⱼ and uⱼ.

15. The operation method of claim 14, wherein a distance between adjacent pixels included in the first image is 1.
